(19) United States
(12) Patent Application Publication
(10) Pub. No.: US 2026/0036481 A1
(43) Pub. Date: Feb. 5, 2026

(54) PRESSURE MEASUREMENT PORT ASSEMBLY FOR INDUCED DRAFT FAN, AND INDUCED DRAFT FAN USING SAME

(71) Applicant: Hubei Queen-Ocean Electrical Appliance Manufacture Co., Ltd., Xiaogan (CN)

(72) Inventors: Jinwu CAI, Xiaogan (CN); Wei LEI, Xiaogan (CN); Haiqi LIN, Xiaogan (CN); Jialin WANG, Xiaogan (CN)

(21) Appl. No.: 19/272,840

(22) Filed: Jul. 17, 2025

(30) Foreign Application Priority Data
Aug. 1, 2024 (CN) 202421858772.4

(51) Int. Cl. G01L 19/00; F04D 17/08; F04D 27/00; F04D 29/42

(52) U.S. Cl. CPC G01L 19/0007; F04D 17/08; F04D 27/001; F04D 29/4226

(57) ABSTRACT

The present invention discloses a pressure measurement port assembly for an induced draft fan, and an induced draft fan using the same. The pressure measurement port assembly for an induced draft fan is disposed on a volute. The pressure measurement port assembly is provided with a pressure measurement through hole communicating an inner cavity of the volute with the outside, wherein the pressure measurement port assembly includes an air pipe mounting segment located on an outer side of the volute and an airflow introduction segment located in the inner cavity of the volute, and the airflow introduction segment includes a curved boss disposed on an outer periphery of the pressure measurement through hole, with an airflow introduction port formed between two opposite ends of the curved boss, thereby allowing airflow in the inner cavity of the volute to pass through the airflow introduction port to enter the pressure measurement through hole. The airflow introduction port is more conducive to introducing the airflow from the inner cavity of the volute into the pressure measurement through hole, so that measured static pressure data is in a larger range than static pressure data measured by a pressure measurement port in the prior art, thereby reducing development difficulty.

### TECHNICAL FIELD

The present invention relates to a pressure measurement port assembly for an induced draft fan, and an induced draft fan using the same.

### BACKGROUND

A current induced draft fan includes a volute and a wind wheel mounted in an inner cavity of the volute. A pressure measurement port assembly for testing an air pressure in the inner cavity of the volute is provided on the volute. The pressure measurement port assembly includes an air pipe mounting tube located on an outer side of the volute, and the air pipe mounting tube is provided with a pressure measurement through hole communicating the inside of the volute with the outside. Due to a small distance from an inner wall of the volute to the wind wheel, with small space available for development and design, no structural design is usually made at an outer periphery of the pressure measurement through hole located on an inner side of the volute. However, static pressure data measured by such a structure is often inaccurate.

### SUMMARY OF THE INVENTION

The present invention provides a pressure measurement port assembly for an induced draft fan, and an induced draft fan using the same, in order to solve the problem that static pressure data measured by a pressure measurement port assembly in the prior art is inaccurate.

A technical solution of the present invention is implemented as follows:

A first object of the present invention is to provide a pressure measurement port assembly for an induced draft fan, disposed on a volute, the pressure measurement port assembly being provided with a pressure measurement through hole communicating an inner cavity of the volute with the outside, wherein the pressure measurement port assembly includes an air pipe mounting segment located on an outer side of the volute and an airflow introduction segment located in the inner cavity of the volute, and the airflow introduction segment includes a curved boss disposed on ap outer periphery of the pressure measurement through hole, with an airflow introduction port formed between two opposite ends of the curved boss, thereby allowing airflow in the inner cavity of the volute to pass through the airflow introduction port to enter the pressure measurement through hole.

A side of the curved boss facing the pressure measurement through hole is an inner side thereof, and a wall on the inner side of the curved boss is in an arc shape.

The curved boss is provided with chamfers at the tops of the two opposite ends of the curved boss.

The pressure measurement port assembly is integrally formed with the volute.

The air pipe mounting segment is of a cylindrical structure, and a reinforcing rib is provided between the air pipe mounting segment and the volute.

A second object of the present invention is to provide an induced draft fan including a pressure measurement port assembly, wherein the pressure measurement port assembly is the above-described pressure measurement port assembly.

Compared with the prior art, the present invention has the following advantages:

1. The pressure measurement port assembly for an induced draft fan is disposed on a volute, the pressure measurement port assembly being provided with a pressure measurement through hole communicating an inner cavity of the volute with the outside, wherein the pressure measurement port assembly includes an air pipe mounting segment located on an outer side of the volute and an airflow introduction segment located in the inner cavity of the volute, and the airflow introduction segment includes a curved boss disposed on an outer periphery of the pressure measurement through hole, with an airflow introduction port formed between two opposite ends of the curved boss, thereby allowing airflow in the inner cavity of the volute to pass through the airflow introduction port and to the pressure measurement through hole. The airflow introduction port is more conducive to introducing the airflow from the inner cavity of the volute into the pressure measurement through hole, so that measured static pressure data is in a larger range than static pressure data measured by a pressure measurement port in the prior art, thereby reducing development difficulty.

2. Other advantages of the present invention are described in detail in the embodiment section.

### BRIEF DESCRIPTION OF THE DRAWINGS

FIG. 1 is a schematic structural diagram of a pressure measurement port assembly for an induced draft fan according to Embodiment 1 of the present invention;

FIG. 2 is an enlarged view at A of FIG. 1;

FIG. 3 is a schematic structural diagram of the pressure measurement port assembly for an induced draft fan from another angle;

FIG. 4 is an enlarged view at B of FIG. 3;

FIG. 5 shows a main view of the pressure measurement port assembly for an induced draft fan; and

FIG. 6 is a C-C cross-sectional view of FIG. 5; and

FIG. 7 is an enlarged view at D of FIG. 6.

### DETAILED DESCRIPTION

To make the objects, technical solutions and advantages of the embodiments of the present invention clearer, the technical solutions in the embodiments of the present invention will be described below clearly and completely in conjunction with the drawings in the embodiments of the present invention. Apparently, the embodiments described are merely some rather than all of the embodiments of the present invention. All other embodiments obtained by those of ordinary skill in the art based on the embodiments of the present invention without creative efforts fall within the scope of protection of the present invention.

### Embodiment 1

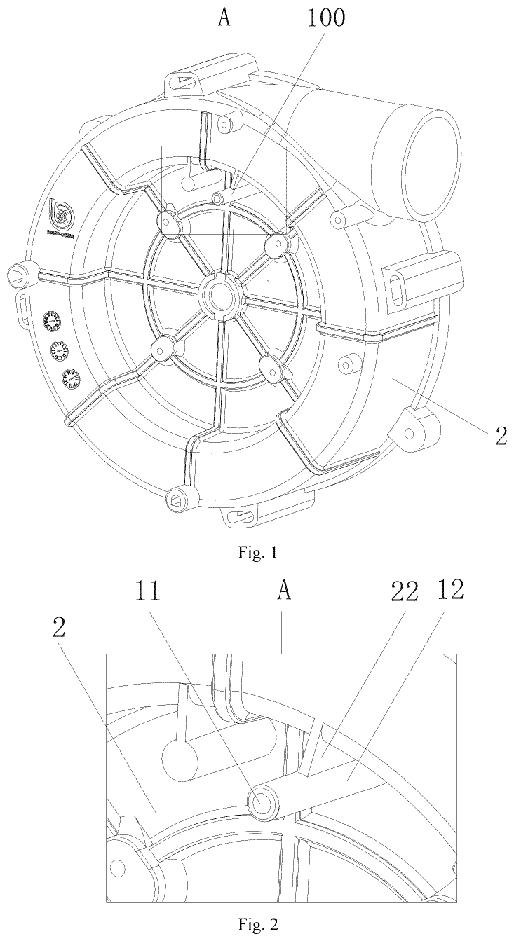

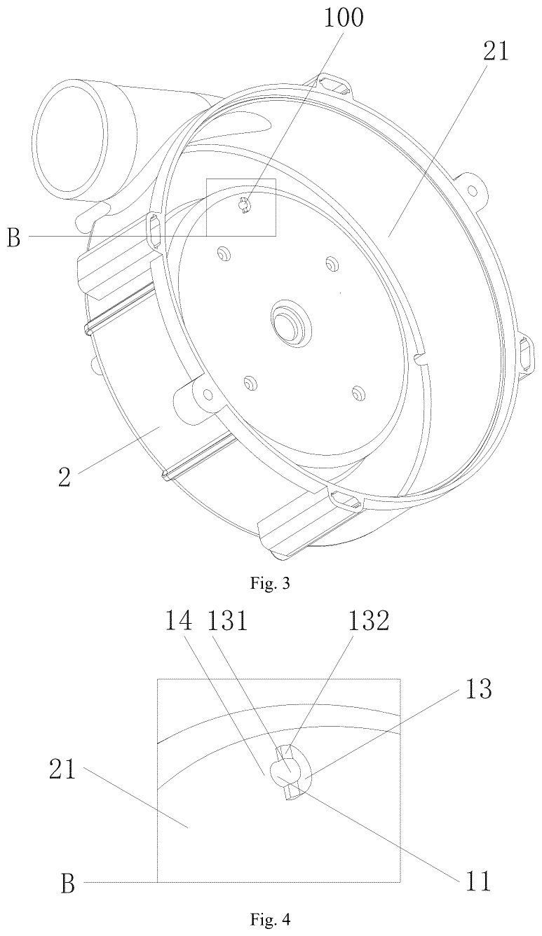

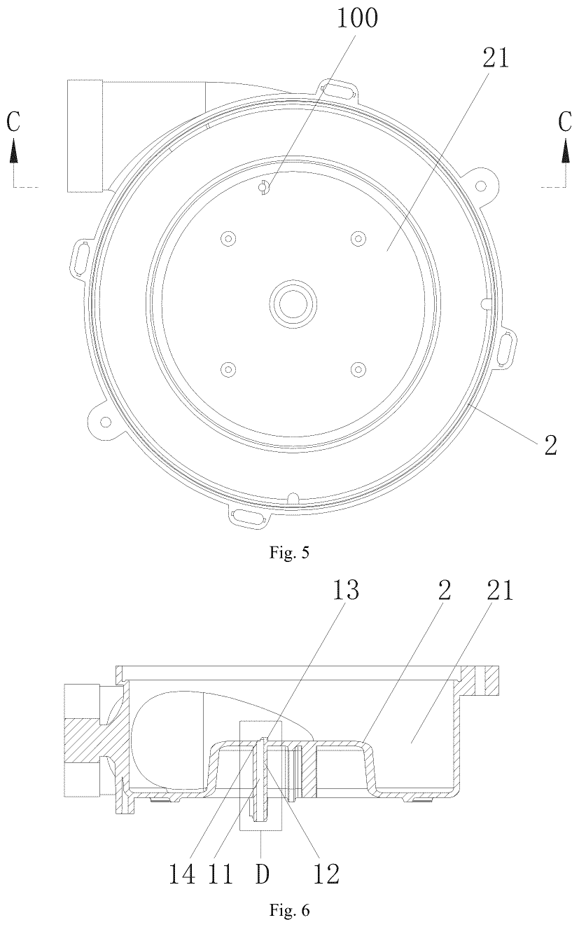

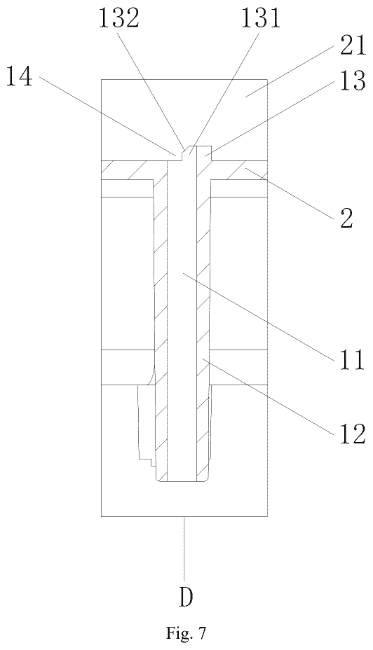

As shown in FIGS. 1 to 7, this embodiment provides a pressure measurement port assembly for an induced draft fan, disposed on a volute 2. The pressure measurement port assembly is provided with a pressure measurement through hole 11 communicating an inner cavity 21 of the volute 2 with the outside. The pressure measurement port assembly includes an air pipe mounting segment 12 located on an outer side of the volute 2 and an airflow introduction segment located in the inner cavity 21 of the volute 2. The airflow introduction segment includes a curved boss 13 disposed on an outer periphery of the pressure measurement through hole 11, with an airflow introduction port 14 formed between two opposite ends of the curved boss 13, thereby allowing airflow in the inner cavity 21 of the volute 2 to pass through the airflow introduction port 14 to enter the pressure measurement through hole 11.

In the pressure measurement port assembly for an induced draft fan, the airflow introduction port 14 is more conducive to introducing the airflow from the inner chamber 21 of the volute 2 into the pressure measurement through hole 11, so that measured static pressure data is more accurate, and the design of the airflow introduction segment is not limited by space. In addition, the size and orientation of the airflow introduction port 14 can be changed according to the position of the pressure measurement port assembly and a distance between an inner wall of the volute 2 and a wind wheel, thereby detecting different static pressure data. The airflow introduction port is more conducive to introducing the airflow from the inner cavity of the volute into the pressure measurement through hole 11, so that measured static pressure data is in a larger range than static pressure data measured by a pressure measurement port in the prior art, thereby reducing development difficulty.

A side of the curved boss 13 facing the pressure measurement through hole 11 is an inner side thereof, and a wall 131 on the inner side of the curved boss 13 is in an arc shape. The arc-shaped wall 131 on the inner side has a better flow guiding effect.

As a preferred option, a cross-section of the wall 131 on the inner side is a semi-circular arc.

The curved boss 13 is provided with chamfers at the tops of the two opposite ends of the curved boss, which can reduce the disturbance to the airflow inside the volute caused by the pressure measurement port and reduce vortices around the pressure measurement port.

The pressure measurement port assembly 1 is integrally formed with the volute 2. This facilitates machining and achieves a lower cost.

The air pipe mounting segment 12 is of a cylindrical structure, and a reinforcing rib 22 is provided between the air pipe mounting segment 12 and the volute 2.

### Embodiment 2

A second object of the present invention is to provide an induced draft fan including a pressure measurement port assembly 100. The pressure measurement port assembly 100 is the pressure measurement port assembly described in Embodiment 1.

By improving the structure of the pressure measurement port assembly 100, the pressure measurement port assembly 100 measures pressure more accurately, and the design of the airflow introduction segment of the pressure measurement port assembly 100 is better.

Finally, it is to be noted that the above embodiments are merely used for illustrating rather than limiting the technical solutions of the present invention. Although the present invention is described in detail with reference to the foregoing embodiments, those of ordinary skill in the art should understand that they can still make modifications to the technical solutions disclosed in the foregoing embodiments or make equivalent substitutions to part of technical features thereof; and such modifications or substitutions should not cause the essence of the corresponding technical solutions to depart from the spirit and scope of the technical solutions of the embodiments of the present invention.

1. A pressure measurement port assembly for an induced draft fan, disposed on a volute (2), the pressure measurement port assembly being provided with a pressure measurement through hole (11) communicating an inner cavity (21) of the volute (2) with the outside, wherein the pressure measurement port assembly comprises an air pipe mounting segment (12) located on an outer side of the volute (2) and an airflow introduction segment located in the inner cavity (21) of the volute (2), and the airflow introduction segment comprises a curved boss (13) disposed on an outer periphery of the pressure measurement through hole (11), with an airflow introduction port (14) formed between two opposite ends of the curved boss (13), thereby allowing airflow in the inner cavity (21) of the volute (2) to pass through the airflow introduction port (14) to enter the pressure measurement through hole (11).

2. The pressure measurement port assembly for an induced draft fan according to claim 1, wherein a side of the curved boss (13) facing the pressure measurement through hole (11) is an inner side thereof, and a wall (131) on the inner side of the curved boss (13) is in an arc shape.

3. The pressure measurement port assembly for an induced draft fan according to claim 1, wherein the curved boss (13) is provided with chamfers (132) at the tops of the two opposite ends of the curved boss (13).

4. The pressure measurement port assembly for an induced draft fan according to claim 2, wherein the curved boss (13) is provided with chamfers (132) at the tops of the two opposite ends of the curved boss (13).

5. The pressure measurement port assembly for an induced draft fan according to claim 3, wherein the pressure measurement port assembly (1) is integrally formed with the volute (2).

6. The pressure measurement port assembly for an induced draft fan according to claim 5, wherein the air pipe mounting segment (12) is of a cylindrical structure, and a reinforcing rib (22) is provided between the air pipe mounting segment (12) and the volute (2).

7. An induced draft fan, comprising a pressure measurement port assembly (100), wherein the pressure measurement port assembly (100) is the pressure measurement port assembly according to claim 1.
